(19) United States
(12) Patent Application Publication
(10) Pub. No.: US 2025/0200878 A1
(43) Pub. Date: Jun. 19, 2025

(54) TRAINING METHOD AND APPARATUS FOR FACIAL MODELING MODEL, MODELING METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Xiaoyu LI, Shenzhen (CN); Benwang CHEN, Shenzhen (CN); Xuan WANG, Shenzhen (CN); Qi ZHANG, Shenzhen (CN); Ying SHAN, Shenzhen (CN)

(21) Appl. No.: 19/068,115

(22) Filed: Mar. 3, 2025

Related U.S. Application Data
(63) Continuation of application No. PCT/CN2023/130344, filed on Nov. 8, 2023.

(30) Foreign Application Priority Data
Feb. 9, 2023 (CN) 202310136271.9

(51) Int. Cl. G06T 17/00; G06T 7/90; G06T 13/40; G06V 10/75; G06V 40/16

(52) U.S. Cl. CPC G06T 17/00; G06T 7/90; G06T 13/40; G06V 10/751; G06V 40/168

(57) ABSTRACT

A training method performed by an electronic device includes obtaining a sample facial image including facial images of a same object from different perspectives at a same moment, performing feature encoding on the sample facial image through an encoder of a facial modeling model to obtain a facial action latent code corresponding to a facial action and one or more facial region latent codes each corresponding to one of one or more facial regions, performing, through a neural radiance field (NeRF) of the facial modeling model, three-dimensional (3D) facial reconstruction on the object based on the one or more facial region latent codes and the facial action latent code to obtain a 3D facial image of the object; obtaining a 3D reconstruction loss between the 3D facial image and the sample facial image, and training the facial modeling model based on the 3D reconstruction loss.

### CROSS-REFERENCE TO RELATED APPLICATIONS

This application is a continuation of International Application No. PCT/CN2023/130344, filed on Nov. 8, 2023, which claims priority to Chinese Patent Application No. 202310136271.9 filed on Feb. 9, 2023, the entire contents of which are incorporated herein by reference.

### FIELD OF THE TECHNOLOGY

Embodiments of this application relate to the field of artificial intelligence (AI), and in particular, to a training method and apparatus for a facial modeling model, a modeling method and apparatus, an electronic device, a computer-readable storage medium, and a computer program product.

### BACKGROUND OF THE DISCLOSURE

In the field of computer vision (CV) technologies, generating a drivable face has a wide range of applications. In practice, reconstructed faces need to change perspectives and expressions based on input signals, and should naturally exhibit speaking expressions synchronized with the driving signals.

In the related art, a manner of driving a face by audio and a manner of driving a face by text are mostly adopted for facial reconstruction. For the manner of driving a face by audio for facial reconstruction, different generation results of a trained network may be produced as a result of a great difference in voices of different people, causing inaccurate driving, and further resulting in a poor simulation effect during facial reconstruction. However, only a two-dimensional (2D) facial image may be generated in the manner of driving a face by text. The manner has a poor simulation effect for driving of a three-dimensional (3D) face. Based on this, the simulation effects during facial reconstruction in the related art are generally poor.

### SUMMARY

In accordance with the disclosure, there is provide a training method, performed by an electronic device, including obtaining a sample facial image including facial images of a same object from different perspectives at a same moment, performing feature encoding on the sample facial image through an encoder of a facial modeling model to obtain a facial action latent code corresponding to a facial action and one or more facial region latent codes each corresponding to one of one or more facial regions, performing, through a neural radiance field (NeRF) of the facial modeling model, three-dimensional (3D) facial reconstruction on the object based on the one or more facial region latent codes and the facial action latent code to obtain a 3D facial image of the object; obtaining a 3D reconstruction loss between the 3D facial image and the sample facial image, and training the facial modeling model based on the 3D reconstruction loss.

Also in accordance with the disclosure, there is provide a three-dimensional (3D) facial modeling method, performed by an electronic device, including determining, in response to receiving an input text, a text phoneme corresponding to the input text, querying for a target region latent code corresponding to the text phoneme and a target action latent code based on a phoneme latent code index indicating a correspondence between a phoneme and a latent code sequence obtained by performing feature encoding on a facial image corresponding to a phoneme based on an encoder of a facial modeling model, performing, through a neural radiance field (NeRF) of the facial modeling model, 3D reconstruction based on the target region latent code and the target action latent code, to obtain one or more facial action images corresponding to the text phoneme, and generating a 3D facial action animation corresponding to the input text based on the one or more facial action images.

Also in accordance with the disclosure, there is provide an electronic device including a memory storing one or more computer-executable instructions, and a processor configured to execute the one or more computer-executable instructions to obtain a sample facial image including facial images of a same object from different perspectives at a same moment, perform feature encoding on the sample facial image through an encoder of a facial modeling model to obtain a facial action latent code corresponding to a facial action and one or more facial region latent codes each corresponding to one of one or more facial regions, perform, through a neural radiance field (NeRF) of the facial modeling model, three-dimensional (3D) facial reconstruction on the object based on the one or more facial region latent codes and the facial action latent code to obtain a 3D facial image of the object, obtain a 3D reconstruction loss between the 3D facial image and the sample facial image, and train the facial modeling model based on the 3D reconstruction loss.

### BRIEF DESCRIPTION OF THE DRAWINGS

FIG. 1 is a schematic diagram showing an implementation environment according to an exemplary embodiment of this application.

FIG. 2 is a flowchart showing a training method for a facial modeling model according to an exemplary embodiment of this application.

FIG. 3 is a flowchart showing a method for determining a three-dimensional (3D) reconstruction loss according to another exemplary embodiment of this application.

FIG. 4 is a structural diagram showing an action neural radiance field (NeRF) according to an exemplary embodiment of this application.

FIG. 5 is a structural diagram showing a region NeRF according to an exemplary embodiment of this application.

FIG. 6 is a structural diagram showing a rendering NeRF according to an exemplary embodiment of this application.

FIG. 7 is a flowchart showing a training method for a facial modeling model according to another exemplary embodiment of this application.

FIG. 8 is a schematic structural diagram showing an encoder according to an exemplary embodiment of this application.

FIG. 9 is a schematic structural diagram showing a facial modeling model according to an exemplary embodiment of this application.

FIG. 10 is a flowchart showing a 3D facial modeling method according to an exemplary embodiment of this application.

FIG. 11 is a flowchart showing generation of a phoneme latent code index according to an exemplary embodiment of this application.

FIG. 12 is a structural block diagram showing a training apparatus for a facial modeling model according to an exemplary embodiment of this application.

FIG. 13 is a structural block diagram showing a 3D facial modeling apparatus according to an exemplary embodiment of this application.

FIG. 14 is a schematic structural diagram of an electronic device according to an exemplary embodiment of this application.

### DESCRIPTION OF EMBODIMENTS

To make objectives, technical solutions, and advantages of this application clearer, implementations of this application are to be further described in detail below with reference to the accompanying drawings.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and involves a wide range of fields including both the hardware-level technology and the software-level technology. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

The CV technology is a field of science that studies how to use a machine to “see,” and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The CV technology generally includes technologies such as image processing, image recognition, image segmentation, image semantic understanding, image retrieval, video processing, video semantic understanding, video content/behavior recognition, three-dimensional (3D) object reconstruction, 3D technology, virtual reality, augmented reality, and simultaneous localization and mapping, and further includes common biometric recognition technologies such as face recognition and fingerprint recognition. The method involved in the embodiments of this application is application of the CV technology in 3D facial reconstruction.

In the related art, a manner of driving a face by audio is mostly adopted to implement 3D facial driving. However, for the manner of driving a face by audio during training, a great difference exists in voices of different people, which may lead to different training results. In addition, during actual use, a pronunciation error may exist in a recorded audio, and an audio needs to be re-recorded, which affects efficiency of controlling a face. However, in related technologies, the manner of driving a face by text may only drive a two-dimensional (2D) facial image, having a poor simulation effect.

In the embodiments of this application, a training method for a facial modeling model is proposed, in which a model for reconstructing a 3D face may be trained. The model may implement decoupling control on different facial attributes, for example, implement decoupling control on different facial regions and facial actions, which helps to implement long-sequence 3D facial modeling. In addition, after the model is trained, a latent code sequence of facial images corresponding to different phonemes may be extracted by using an encoder in the model. During application, queries may be performed to obtain a latent code sequence corresponding to a text phoneme. Long-sequence 3D facial modeling may be performed by using a neural radiance field (NeRF) in the model, to obtain a 3D facial action animation corresponding to a text, thereby implementing a manner of driving a 3D face by text and improving applicability of facial driving.

The method provided in the embodiments of this application may be applied to a scenario of driving a face by text. For example, during a video conference, a participant may input a text through a program. When a computer device receives the input text, queries may be performed based on a text phoneme of the input text to obtain a corresponding latent code sequence. Therefore, 3D reconstruction is performed on the latent code sequence through the NeRF, to obtain a 3D facial action animation, thereby implementing a simulated speech and improving authenticity of the simulation. Certainly, the method may further be applied to another scenario in which a face needs to be driven, for example, applied to scenarios such as network teaching, a virtual anchor, and virtual socializing, which is not limited in the embodiments.

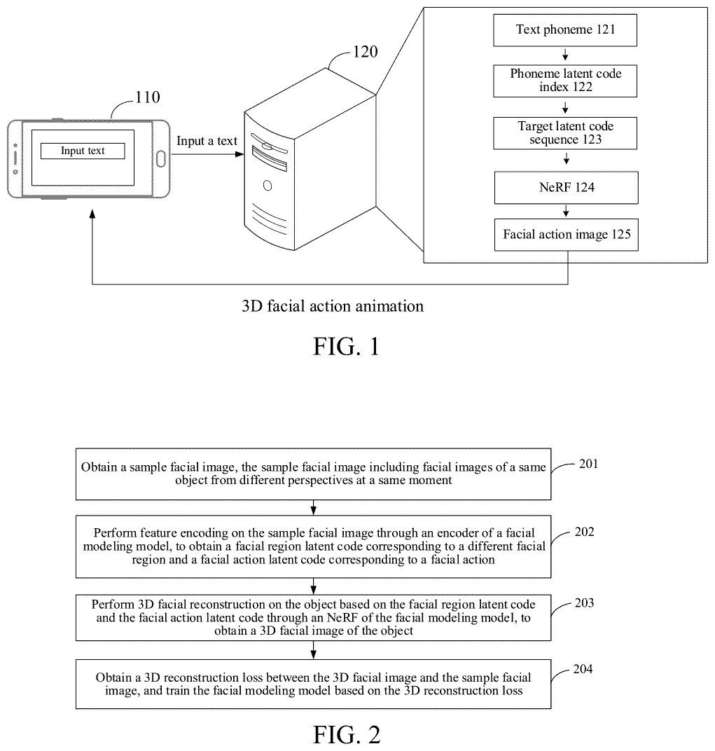

FIG. 1 is a schematic diagram showing an implementation environment according to an exemplary embodiment of this application. The implementation environment includes a terminal 110 and a server 120. The terminal 110 performs data communication with the server 120 through a communication network. In some embodiments, the communication network may be a wired network or a wireless network, and the communication network may be at least one of a local area network, a metropolitan area network, or a wide area network.

The terminal 110 is an electronic device having a function of driving a face by text. The electronic device may be a mobile terminal such as a smart phone, a tablet computer, or a laptop portable computer, or may be a terminal such as a desktop computer or a projection computer, which is not limited in this embodiment of this application. In addition, the terminal may provide the function of driving a face by text through a conference program, a live streaming program, a teaching application, and the like, which is not limited in this embodiment of this application.

The server 120 may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform. In this embodiment of this application, the server 120 is a background server that provides the function of driving a face by text in the terminal 110, and may generate a 3D facial action animation based on a text inputted by a user and return the 3D facial action animation to the terminal 110.

As shown in FIG. 1, the terminal 110 may receive an input text inputted by the user, and then transmit the input text to the server 120. The server 120 has a phoneme latent code index 122 stored therein. The server 120 determines a text phoneme 121 corresponding to the input text, and queries the phoneme latent code index 122 for a corresponding target latent code sequence 123. Then the target latent code sequence 123 is inputted to an NeRF 124 to perform 3D reconstruction, to obtain a facial action image 125 corresponding to each text phoneme, thereby generating a 3D facial action animation based on the facial action image 125 and feeding back the 3D facial action animation to the terminal 110.

The phoneme latent code index is established based on results of encoding different facial images by an encoder in a facial modeling model. The encoder of the facial modeling model and the NeRF are pre-trained through a sample facial image. The training process may be performed by the server 120. Subsequently, the server 120 establishes the phoneme latent code index by using the trained encoder, and performs the 3D reconstruction by using the NeRF.

In another possible implementation, the foregoing 3D reconstruction process may also be performed by the terminal 110. The server 120 transmits a trained model to the terminal 110, and the terminal 110 implements the 3D reconstruction locally without the help of the server 120. Alternatively, the facial modeling model may be trained on the terminal 110, and the terminal 110 performs the 3D reconstruction process. This is not limited in this embodiment of this application.

To facilitate description, the following embodiments are explained using the method executed by electronic devices as an example.

FIG. 2 is a flowchart showing a training method for a facial modeling model according to an exemplary embodiment of this application. This embodiment is described by using an example in which the method is applied to a computer device. The method includes the following operations.

Operation 201: Obtain a sample facial image, the sample facial image including facial images of a same object from different perspectives at a same moment.

In some embodiments, the electronic device may first obtain a set of sample images from a plurality of perspectives. In a possible implementation, facial images of the same object from different perspectives may be acquired by using a multi-perspective camera photographing system, to obtain the facial images from different perspectives at the same moment. Exemplarily, a reader may be given a text in any language. When the reader reads the text, the multi-perspective camera photographing system may photograph the reader and obtain a video of the reader reading the text from a plurality of perspectives. During the photographing, only a face of the reader can be photographed to obtain a multi-perspective facial video. Then the electronic device may process the multi-perspective facial video, to obtain facial images of the reader from different perspectives at the same moment. The facial images at the same moment are a set of sample facial images. The electronic device may obtain a plurality of sets of sample facial images by processing the multi-perspective facial video.

Exemplarily, the electronic device may obtain the facial images of the reader from three perspectives. To be specific, a set of sample facial images includes facial images from a front perspective, a left side perspective, and a right side perspective to comprehensively cover facial features.

Operation 202: Perform feature encoding on the sample facial image through an encoder of a facial modeling model, to obtain facial region latent codes corresponding to different facial regions and a facial action latent code corresponding to a facial action.

In this embodiment of this application, a facial modeling model is provided. The model includes an encoder-NeRF structure. In a possible implementation, the encoder is configured to encode the facial images from the plurality of perspectives, to obtain facial region latent codes corresponding to different facial regions and a facial action latent code corresponding to a facial action. To be specific, the electronic device inputs a set of sample facial images into the encoder. Feature encoding is performed on the sample facial images through the encoder of the facial modeling model, to obtain the facial region latent code and the facial action latent code corresponding to the facial image at a corresponding moment. In other words, the sample facial images are inputted into the encoder of the facial modeling model for feature encoding, to obtain the facial region latent codes corresponding to different facial regions and the facial action latent code corresponding to the facial action.

A latent code is a feature vector configured for characterizing a facial feature. The facial region latent code is configured for characterizing a region feature of a local facial region. The facial action latent code is configured for characterizing a facial action feature, such as a mouth action, an eye action, or a nose action.

Different facial regions have different states. In some embodiments, the facial region may be divided into an upper region and a lower region. To be specific, a facial region latent code corresponding to an upper half face and a facial region latent code corresponding to a lower half face are encoded. Alternatively, the facial region may also be divided into a left region and a right region. To be specific, a facial region latent code corresponding to a left half face and a facial region latent code corresponding to a right half face are encoded. A facial division manner is not limited in this embodiment. Similarly, a quantity of divided regions is not limited. For example, a face may be divided into 2 regions, 3 regions, or 4 regions. In this embodiment, decoupling control of the face is implemented through the region latent codes of different facial regions and the action latent codes of the facial actions.

Exemplarily, a front facial image, a left facial image, and a right facial image of the reader at the same moment may be inputted into the encoder to obtain facial region latent codes and the facial action latent codes of the face of the reader at the moment.

Operation 203: Perform 3D facial reconstruction on the object based on the facial region latent code and the facial action latent code through an NeRF of the facial modeling model, to obtain a 3D facial image of the object.

The NeRF is a model configured to perform 3D reconstruction, which represents a 3D scene as a radiance field approximated by a neural network. A color and a volume density of each point and each perspective direction in the scene are described in the radiance field. In this embodiment of this application, the NeRF includes a plurality of NeRFs, to implement decoupling control of each part of the face.

In a possible implementation, the NeRF may respectively include an NeRF configured to extract a facial region feature and an NeRF configured to extract a facial action feature. Finally, the 3D facial reconstruction is performed through the plurality of NeRFs, to obtain a pixel color and a pixel density corresponding to each pixel. Based on the pixel color and the pixel density, the 3D facial image can be rendered.

During actual implementation, a process of performing the 3D facial reconstruction on the object based on the facial region latent code and the facial action latent code through the NeRF of the facial modeling model to obtain the 3D facial image of the object is inputting the facial region latent code and the facial action latent code into the NeRF of the facial modeling model to perform the 3D facial reconstruction, to obtain the 3D facial image.

Operation 204: Obtain a 3D reconstruction loss between the 3D facial image and the sample facial image, and train the facial modeling model based on the 3D reconstruction loss.

The facial modeling model is trained based on the 3D reconstruction loss herein. In other words, the encoder and the NeRF of the facial modeling model are trained based on the 3D reconstruction loss between the 3D facial image and the sample facial image.

After the 3D facial image is rendered, the 3D reconstruction loss may be determined based on a difference between the 3D facial image and the sample facial image, and the facial modeling model is trained by using the 3D reconstruction loss.

In a possible implementation, the model may be trained through gradient updating or back propagation. When a 3D reconstruction loss function reaches a convergence condition, the training may be ended, and the facial modeling model for the 3D facial modeling may be obtained. The facial modeling model may implement the decoupling control of the face. During subsequent use, only the facial action latent code may be changed only when a facial action changes. However, when a certain local region changes, only the facial region latent code corresponding to the local region can be changed, so as to implement the long-sequence 3D facial modeling.

In the embodiments of this application, feature encoding is performed on the sample facial images from a plurality of perspectives, to obtain the facial region latent code and the facial action latent code corresponding to the sample facial image, which are configured for characterizing region features of different facial regions and action features of a face. Then 3D reconstruction is performed through the facial region latent code and the facial action latent code, to obtain the 3D facial image. Therefore, a facial modeling model that may perform decoupling control on the face is trained based on the difference between the 3D facial image and the sample facial image. When a model is configured for 3D facial modeling, decoupling control may be performed on different facial regions and facial actions, so that a facial image with different facial regions and different facial action combinations may be generated. During the 3D facial modeling, only part of the latent code that needs to be changed needs to be adjusted, so that the long-sequence 3D facial modeling may be implemented.

In some embodiments, the NeRF includes a region NeRF, an action NeRF, and a rendering NeRF. Decoupling control of different faces is implemented through different NeRFs, so as to reconstruct the 3D facial image. A description is provided below by using an exemplary embodiment.

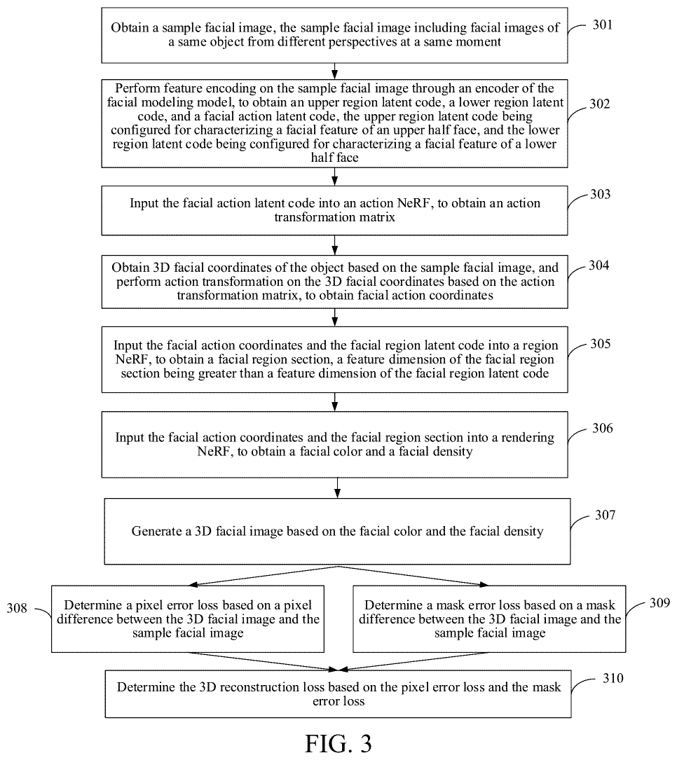

FIG. 3 is a flowchart showing a method for determining a 3D reconstruction loss according to another exemplary embodiment of this application. This embodiment is described by using an example in which the method is applied to an electronic device. The method includes the following operations.

Operation 301: Obtain a sample facial image, the sample facial image including facial images of a same object from different perspectives at a same moment.

For an implementation of this operation, reference may be made to the foregoing operation 201. Details are not described in this embodiment again.

Operation 302: Perform feature encoding on the sample facial image through an encoder of the facial modeling model, to obtain an upper region latent code, a lower region latent code, and a facial action latent code, the upper region latent code being configured for characterizing a facial feature of an upper half face, and the lower region latent code being configured for characterizing a facial feature of a lower half face.

In some embodiments, the face is divided into an upper half and a lower half. To be specific, sample facial images from a plurality of perspectives are inputted into the encoder for feature encoding, to obtain an upper region latent code corresponding to an upper half face, a lower region latent code corresponding to a lower half face, and a facial action latent code corresponding to a facial action.

In a possible implementation, the encoder may first perform feature encoding on the sample facial images from a plurality of perspectives to obtain a facial state latent code for characterizing an overall facial state, and then decouple the facial state latent code to obtain the facial region latent code and the facial action latent code.

Exemplarily, the sample facial images from three perspectives have an image size of 512×374, a latent code size of the facial latent code is 256, and a latent code size of the facial region latent code and the facial action latent code obtained through decoupling is 128.

Operation 303: Input the facial action latent code into the action NeRF, to obtain an action transformation matrix.

The decoupling control of each part of the face is implemented through a plurality of NeRFs based on the NeRF of the latent code. The NeRF includes the action NeRF, which is configured to implement decoupling control of a facial action.

The action NeRF may extract a feature of the facial action latent code, to obtain the action transformation matrix corresponding to the facial action. The facial action transformation may be implemented through the action transformation matrix.

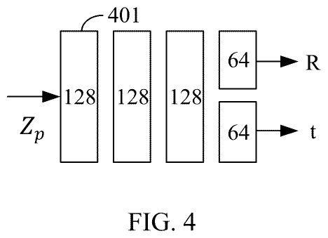

The action NeRF includes a multi-layer fully connected network. FIG. 4 is a structural diagram showing an action NeRF according to an exemplary embodiment of this application. The action NeRF includes a 4-layer fully connected network 401 with a network width of 128. A facial action latent code Zₚ is inputted into the action NeRF to obtain an action transformation matrix (R, t).

Operation 304: Obtain 3D facial coordinates of the object based on the sample facial image, and perform action transformation on the 3D facial coordinates based on the action transformation matrix, to obtain facial action coordinates.

During actual implementation, after the sample facial image is determined, a 3D coordinate system for the sample facial image is constructed, so as to obtain the 3D facial coordinates of the object corresponding to the sample facial image based on the 3D coordinate system.

After the action transformation matrix is obtained, the 3D facial coordinates of may be transformed through the action transformation matrix, to obtain the facial action coordinates corresponding to the facial action.

The transformation manner is as follows:

$${x}^{′} = Rx + t \qquad Equation ( 1 )$$

where x represents 3D coordinates before the transformation, and (R, t) is a transformation matrix.

After action transformation is performed on the 3D facial coordinates (x, y, z), facial action coordinates (x′, y′, z′) may be obtained.

In another possible implementation, the coordinates (x, y, z) may also be divided by the action transformation matrix (R, t) to obtain transformed facial action coordinates.

Operation 305: Input the facial action coordinates and the facial region latent code into the region NeRF, to obtain a facial region section, a feature dimension of the facial region section being greater than a feature dimension of the facial region latent code.

The NeRF further includes the region NeRF, which is configured to implement decoupling control of different facial regions. The region NeRF is configured to perform feature mapping, and map the latent code to a feature vector of a high-dimensional space. In other words, a section is mapping of the latent code in the high-dimensional space. In a possible implementation, a computer device inputs the facial action coordinates and the facial region latent code into the region NeRF, to obtain a facial region section in the high-dimensional space. A feature dimension of the facial region section is greater than a feature dimension of the facial region latent code, so as to learn more facial region features.

The facial region latent code includes an upper region latent code and a lower region latent code. Correspondingly, the region NeRF may also include an upper NeRF for controlling an upper half face, and further includes a lower NeRF for controlling a lower half face.

In some embodiments, the facial action coordinates and the upper region latent code are inputted into the upper NeRF, to obtain an upper region section. To be specific, the facial action coordinates (x′, y′, z′) and the upper region latent code z_{f} are inputted into the upper NeRF, to obtain an upper region section w_{f}.

In some embodiments, the facial action coordinates and the lower region latent code are inputted into the lower NeRF, to obtain a lower region section. In other words, the facial action coordinates (x′, y′, z′) and a lower region latent code zₘ are inputted into the lower NeRF, to obtain a lower region section wₘ.

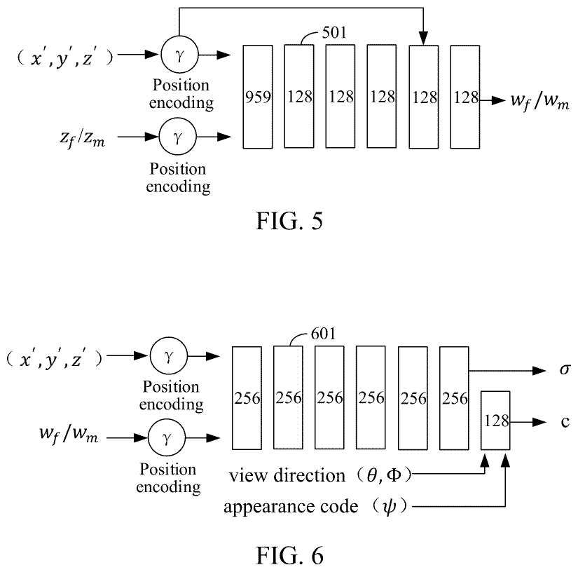

In some embodiments, the region NeRF also adopts a multi-layer fully connected network. Exemplarily, FIG. 5 is a structural diagram showing a region NeRF according to an exemplary embodiment of this application. The region NeRF includes a 6-layer fully connected network 501 with a network width of 128. Position encoding is performed on facial action coordinates (x′, y′, z′) and a facial region latent code (z_{f}/zₘ), and then the encoded facial action coordinates and the encoded facial region latent code are inputted into the region NeRF, to obtain a facial region section (w_{f}/wₘ).

After the upper region section and the lower region section are obtained, the facial region section is obtained based on the upper region section and the lower region section.

Operation 306: Input the facial action coordinates and the facial region section into a rendering NeRF, to obtain a facial color and a facial density.

The NeRF further includes the rendering NeRF, which is configured to perform 3D facial reconstruction. After the upper region section and the lower region section are obtained, the facial action coordinates and the facial region section (including the upper region section and the lower region section) may be inputted into the rendering NeRF to obtain the facial color and the facial density.

During the 3D reconstruction, a photographing view direction and an appearance code further need to be inputted into the fully connected network of the rendering NeRF to perform the 3D reconstruction, to obtain a pixel color and a pixel density of each pixel point corresponding to the 3D face.

In some embodiments, the rendering NeRF also adopts the multi-layer fully connected network. Exemplarily, FIG. 6 is a structural diagram showing a rendering NeRF according to an exemplary embodiment of this application. The rendering NeRF includes a 7-layer fully connected network 601 with a network width of 256. Position encoding is performed on facial action coordinates (x′, y′, z′) and a facial region section (w_{f}/wₘ), then the encoded facial action coordinates and the encoded facial region section are inputted into the rendering NeRF, and a view direction (θ, Φ) and an appearance code (ψ) may be inputted into a last layer of the fully connected network to perform 3D reconstruction, to obtain a facial RGB color c and a facial density (mask) σ.

Operation 307: Generate a 3D facial image based on the facial color and the facial density.

Operation 308: Determine a pixel error loss based on a pixel difference between the 3D facial image and the sample facial image.

After the 3D reconstruction, the 3D reconstruction loss may be determined by using the difference between the sample facial image and the 3D facial image. In some embodiments, the pixel error loss may be determined based on the pixel difference. The pixel difference may be determined based on an RGB difference of each pixel point in the sample facial image and the 3D facial image. In a possible implementation, a mean squared error (MSE) loss between pixels may be calculated based on a difference between the pixels, to obtain the pixel error loss.

Operation 309: Determine a mask error loss based on a mask difference between the 3D facial image and the sample facial image.

In addition, the mask error loss may further be determined based on the mask difference between faces. In a possible implementation, a mask corresponding to the sample facial image may be obtained, and a cross entropy loss between the mask and a mask of the 3D facial image is calculated to obtain the mask error loss.

Operation 310: Determine the 3D reconstruction loss based on the pixel error loss and the mask error loss.

The 3D reconstruction loss is a sum of the pixel error loss and the mask error loss, which is shown in the following equation:

$${ℒ}_{rec} ( p ) = {ℒ}_{mse} ( I ( p ) , \hat{I} ( p ) ) + {λℒ}_{ce} ( {M}_{h} ( p ) , α ( p ) ) \qquad Equation ( 2 )$$

where [symbol] ₘₛₑ is a pixel error loss between the sample facial image I and the 3D facial image Î, [symbol] _{ce} is a mask error loss between a facial mask Mₕ corresponding to the sample facial image and a mask (an opaque image) α corresponding to the 3D facial image, and λ is a balance parameter.

During actual implementation, after the 3D reconstruction loss is determined, a facial modeling model is trained based on the 3D reconstruction loss. In other words, the encoder and the NeRF are trained based on the 3D reconstruction loss. To be specific, the encoder and the NeRF (including an action NeRF, a region NeRF, and a rendering NeRF) may be trained through the 3D reconstruction loss, to obtain the facial modeling model.

In this embodiment, decoupling control of a facial action and different regions is implemented through the action NeRF and the region NeRF respectively, and then the 3D reconstruction is performed through the rendering NeRF to obtain the 3D facial image. Since the decoupling control is allowed, only a corresponding facial latent code may be changed subsequently to improve efficiency of the 3D facial reconstruction and implement efficient long-sequence 3D facial modeling.

To ensure accurate separation of different facial attributes, in a possible implementation, regularization is applied to the upper half face and the lower half face to decouple the upper half face from the lower half face. To be specific, a decoupling loss is determined by controlling a variable, and the encoder is trained by using the decoupling loss to improve accuracy of latent codes corresponding to different attributes obtained by decoupling. A description is provided below by using an exemplary embodiment.

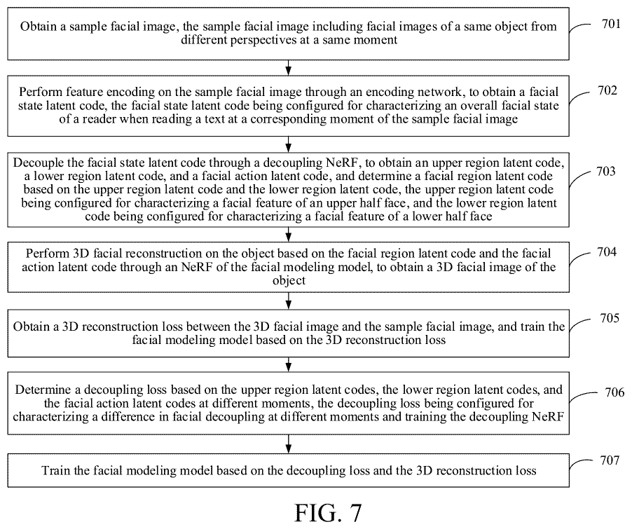

FIG. 7 is a flowchart showing a training method for a facial modeling model according to another exemplary embodiment of this application. This embodiment is described by using an example in which the method is applied to an electronic device. The method includes the following operations.

Operation 701: Obtain a sample facial image, the sample facial image including facial images of a same object from different perspectives at a same moment.

For an implementation of this operation, reference may be made to the foregoing operation 201. Details are not described in this embodiment again.

Operation 702: Perform feature encoding on the sample facial image through an encoding network, to obtain a facial state latent code, the facial state latent code being configured for characterizing an overall facial state of a reader when reading a text at a corresponding moment of the sample facial image.

During actual implementation, feature encoding is performed on the sample facial image through the encoding network, to obtain the facial state latent code. In other words, the sample facial image is inputted into the encoding network for feature encoding, to obtain the facial state latent code.

The encoder includes the encoding network and a decoupling NeRF. The encoding network is configured to perform feature encoding on the sample facial images from a plurality of perspectives, to obtain the facial state latent code that characterizes the overall facial state.

In some embodiments, the encoding network includes a convolutional layer and a cascading layer. The convolutional layer is configured to perform 2D convolution on an inputted sample facial image. The cascading layer is configured to cascade an intermediate representation corresponding to each image to obtain the facial state latent code.

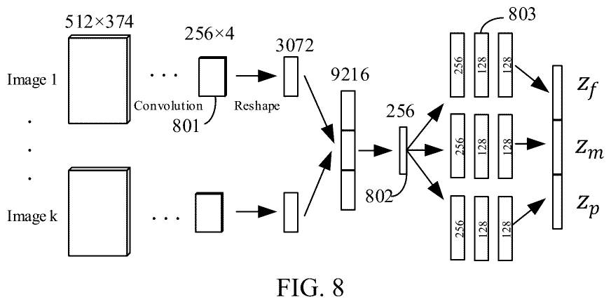

Exemplarily, FIG. 8 is a schematic structural diagram showing an encoder according to an exemplary embodiment of this application. A sample input image includes an image 1 to an image k. The image 1 to the image k having a size of 512×374 are respectively inputted into a convolutional layer of an encoding network for convolution, and an intermediate vector 801 having a size of 4×256 is obtained. Then the intermediate vector 801 is reshaped and cascaded to obtain a facial state latent code Z 802 having a size cof 256.

Operation 703: Decouple the facial state latent code through the decoupling NeRF, to obtain an upper region latent code, a lower region latent code, and the facial action latent code, and determine the facial region latent code based on the upper region latent code and the lower region latent code, the upper region latent code being configured for characterizing a facial feature of an upper half face, and the lower region latent code being configured for characterizing a facial feature of a lower half face.

During actual implementation, the facial state latent code is decoupled through the decoupling NeRF, to obtain the upper region latent code, the lower region latent code, and the facial action latent code. In other words, the facial state latent code is inputted into the decoupling NeRF for decoupling, to obtain the upper region latent code, the lower region latent code, and the facial action latent code.

The encoder further includes the decoupling NeRF. The decoupling NeRF is configured to decouple the overall latent code, to obtain facial region latent codes (including the upper region latent code and the lower region latent code) and facial action latent codes of different regions.

In some embodiments, the decoupling NeRF includes a multi-layer fully connected network. As shown in FIG. 8, the decoupling NeRF includes a three-layer fully connected network 803. After being inputted into the decoupling NeRF, the facial state latent code Z may be decoupled into an upper region latent code z_{f}, a lower region latent code zₘ, and a facial action latent code zₚ.

Operation 704: Perform 3D facial reconstruction on the object based on the facial region latent code and the facial action latent code through an NeRF of the facial modeling model, to obtain a 3D facial image of the object.

Operation 705: Obtain a 3D reconstruction loss between the 3D facial image and the sample facial image, and train the facial modeling model based on the 3D reconstruction loss.

For implementations of operations 704-705, reference may be made to operations 303-309 in the foregoing embodiments. Details are not described in this embodiment again.

Operation 706: Determine a decoupling loss based on the upper region latent codes, the lower region latent codes, and the facial action latent codes at different moments, the decoupling loss being configured for characterizing a difference in facial decoupling at different moments and training the decoupling NeRF.

In a possible implementation, training of the decoupling NeRF is implemented by controlling a variable. When only a local region latent code is changed, a rendering result of another region is not affected. Therefore, the decoupling loss may be determined through rendering results corresponding to latent code sets at different moments. The manner may include operations 706a-706e (not shown).

Operation 706a: Obtain a first upper region latent code, a first lower region latent code, and a first facial action latent code corresponding to the sample facial image at a first moment, and obtain a second upper region latent code, a second lower region latent code, and a second facial action latent code corresponding to the sample facial image at a second moment.

First, an electronic device may encode the sample facial images at two different moments (a first moment t₁ and a second moment t₂) through the encoder, to respectively obtain a first upper region latent code, a first lower region latent code, and a first facial action latent code (i.e., {zₚ^{t}^{₁}, zₘ^{t}^{₁}, z_{f}^{t}^{₁}}) at the first moment, and a second upper region latent code, a second lower region latent code, and a second facial action latent code (i.e., {zₚ^{t}^{₂}, zₘ^{t}^{₂}, z_{f}^{t}^{₂}}) at the second moment.

Operation 706b: Determine an upper decoupling loss based on the first upper region latent code, the first facial action latent code, and the second lower region latent code.

When only the lower region latent code at the first moment is changed, a rendering result of the upper half face is not affected. Therefore, in a possible implementation, the upper decoupling loss may be determined based on a difference between a 3D facial image, which is obtained through rendering based on a changed latent code set resulting from a change to the lower region latent code at the first moment, and the upper half face in the sample facial image corresponding to the first moment. In a possible implementation, the manner may include the following operations.

Operation I: Input the first upper region latent code, the first facial action latent code, and the second lower region latent code into the NeRF, to obtain a first facial image.

The electronic device may change the first lower region latent code at the first moment to the second lower region latent code at the second moment, to obtain a first latent code set {zₚ^{t}^{₁}, zₘ^{t}^{₂}, z_{f}^{t}^{₁}}. Then the first latent code set is inputted into the NeRF for 3D facial reconstruction, to obtain a first facial image Î_{f}_{₁}.

Operation II: Determine the upper decoupling loss based on a difference between an upper half face in the first facial image and an upper half face in the sample facial image at the first moment.

Since only a latent code of the lower half face is changed, a rendered image of the upper half face is to be the same as an image of the upper half face in the sample facial image, and the upper decoupling loss may be determined through a difference between the images of the upper half face.

In a possible implementation, the upper decoupling loss is as follows:

$${ℒ}_{face} ( p ) = {ℒ}_{mse} ( {\hat{I}}_{{f}_{1}} ( p ) * {M}_{f} ( p ) , {I}^{{t}_{1}} ( p ) * {M}_{f} ( p ) ) \qquad Equation ( 3 )$$

where M_{f} is a mask of the upper half face, Î_{f}_{₁} is a first facial image rendered based on the first latent code set, I^{t}^{₁} is a sample facial image corresponding to the first moment, and [symbol] ₘₛₑ is an MSE loss between the two.

Operation 706c: Determine a lower decoupling loss based on the first lower region latent code, the first facial action latent code, and the second upper region latent code.

Similarly, when only the upper region latent code at the first moment is changed, a rendering result of the lower half face is not affected. Therefore, in a possible implementation, a 3D facial image may be rendered based on a changed latent code set by changing the upper region latent code at the first moment. The lower decoupling loss is determined through a difference between the 3D facial image and the lower half face of the sample facial image corresponding to the first moment. In a possible implementation, the manner may include the following operations.

Operation I: Input the first lower region latent code, the first facial action latent code, and the second upper region latent code into the NeRF, to obtain a second facial image.

The electronic device may change the first upper region latent code at the first moment to the second upper region latent code at the second moment, to obtain a second latent code set {zₚ^{t}^{₁}, zₘ^{t}^{₁}, z_{f}^{t}^{₂}}. Then the second latent code set is inputted into the NeRF for 3D facial reconstruction, to obtain a second facial image Îₘ_{₁}.

Operation II: Determine the lower decoupling loss based on a difference between a lower half face in the second facial image and a lower half face in the sample facial image at the first moment.

Since only a latent code of the upper half face is changed, a rendered image of the lower half face is to be the same as an image of the lower half face in the sample facial image corresponding to the first moment, and the lower decoupling loss may be determined through a difference between the images of the lower half face.

In a possible implementation, the lower decoupling loss is as follows:

$${ℒ}_{mou} ( p ) = {ℒ}_{mse} ( {\hat{I}}_{{m}_{1}} ( p ) * {M}_{m} ( p ) , {I}^{{t}_{1}} ( p ) * {M}_{m} ( p ) ) \qquad Equation ( 4 )$$

where Mₘ is a mask of the lower half face, Îₘ_{₁} is a second facial image rendered based on the second latent code set, I^{t}^{₁} is a sample facial image corresponding to the first moment, and [symbol] ₘₛₑ is an MSE loss between the two.

Operation 706d: Determine an action decoupling loss based on the second facial action latent code, the first upper region latent code, and the first lower region latent code.

To improve accuracy of decoupling the facial action, the action decoupling loss is further introduced. When the facial action is changed, a mask of the rendered image is not affected. Therefore, the 3D facial image may be rendered based on a changed latent code set by changing the facial action latent code at the first moment, and the action decoupling loss is determined through a difference between the 3D facial image and the mask of the sample facial image corresponding to the first moment. The manner may include the following operations.

Operation I: Input the second facial action latent code, the first upper region latent code, and the first lower region latent code into the NeRF, to obtain a third facial image.

In a possible implementation, the first facial action latent code at the first moment may be changed to the second facial action latent code at the second moment, to obtain a third latent code set {zₚ^{t}^{₂}, zₘ^{t}^{₁}, z_{f}^{t}^{₁}}. Then the third latent code set may be inputted into the NeRF to perform 3D reconstruction, to obtain the third facial image.

Operation II: Determine the action decoupling loss based on a difference between a mask of the third facial image and a mask of the sample facial image at the first moment.

In a case that the facial action changes, a facial projection does not change. To be specific, the facial mask corresponding to the third facial image is to be the same as the facial mask corresponding to the sample facial image at the first moment, and the action decoupling loss may be determined based on the difference between the two masks.

The action decoupling loss is shown in the following equation:

$${ℒ}_{pose} ( p ) = {ℒ}_{ce} ( {\hat{M}}_{{p}_{1}} ( p ) , {M}_{h} ( p ) ) \qquad Equation ( 5 )$$

where \hat{M}ₚ_{₁} is a facial mask corresponding to the third facial image, and Mₕ(p) is a facial mask corresponding to the sample facial image at the first moment.

In this embodiment, an execution sequence of determining the upper decoupling loss, determining the lower decoupling loss, and determining the action decoupling loss (i.e., operations 706b-706d) is not limited, and the three operations may be performed simultaneously or in sequence. This embodiment only illustrates the implementation, and does not limit the sequence.

Operation 706e: Determine the decoupling loss based on the upper decoupling loss, the lower decoupling loss, and the action decoupling loss.

After the upper decoupling loss, the lower decoupling loss, and the action decoupling loss are determined, a sum of the upper decoupling loss, the lower decoupling loss, and the action decoupling loss may be determined as the decoupling loss for training the decoupling NeRF.

Operation 707: Train the facial modeling model based on the decoupling loss and the 3D reconstruction loss.

After the decoupling loss is determined, the process of training the facial modeling model based on the 3D reconstruction loss may be training the facial modeling model based on the decoupling loss and the 3D reconstruction loss.

In the foregoing embodiments, the encoder is further trained through the 3D reconstruction loss, including the training of the decoupling NeRF. Therefore, a total loss corresponding to the decoupling NeRF is as follows:

$$ℒ = {ℒ}_{rec} + {λ}_{1} {ℒ}_{face} + {λ}_{2} {ℒ}_{mou} + {λ}_{3} {ℒ}_{pose} \qquad Equation ( 6 )$$

where [symbol] _{rec} is a 3D reconstruction loss, [symbol] _{face} is an upper decoupling loss, [symbol] ₘₒᵤ is a lower decoupling loss, and [symbol] ₚₒₛₑ is an action decoupling loss.

The decoupling NeRF may be trained through the total loss, to improve accuracy of decoupling of the decoupling NeRF.

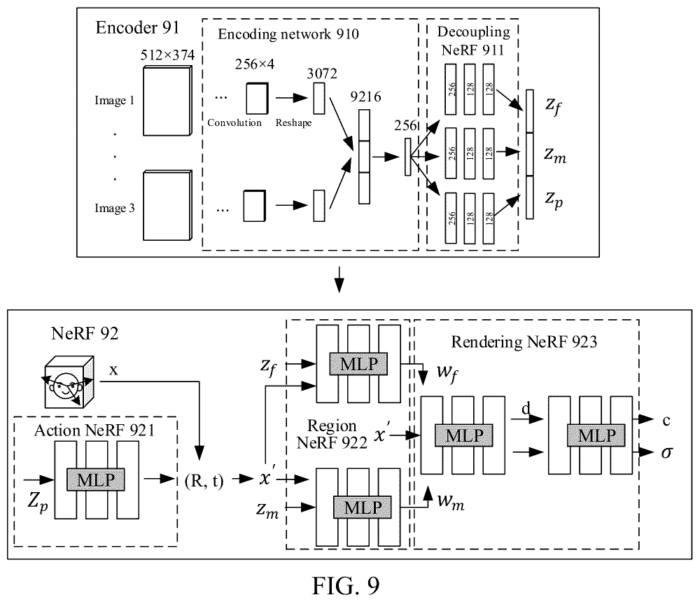

In a possible implementation, a model structure of an overall facial modeling model is shown in FIG. 9. FIG. 9 is a schematic structural diagram showing a facial modeling model according to an exemplary embodiment of this application, which includes an encoder 91 and an NeRF 92. The encoder 91 includes an encoding network 910 and a decoupling NeRF 911. When sample facial images from three perspectives are inputted, the encoding network 910 may perform encoding to obtain a facial state latent code. Then the decoupling NeRF 911 may decode the facial state latent code, to obtain an upper region latent code z_{f}, a lower region latent code zₘ, and a facial action latent code zₚ.

After the encoding is ended, the upper region latent code z_{f}, the lower region latent code zₘ, and the facial action latent code zₚ may be inputted into the NeRF 92. The NeRF 92 includes an action NeRF 921, a region NeRF 922, and a rendering NeRF 923. The action NeRF 921 is configured to generate an action transformation matrix (R, t) based on the facial action latent code zₚ. Then 3D facial coordinates x are changed to obtain facial action coordinates x′. Then the upper region latent code z_{f}, the lower region latent code zₘ, and the facial action coordinates x′ may be inputted into the region NeRF 922, and an upper region section w_{f} and a lower region section wₘ are generated through the region NeRF 922. The upper region section w_{f}, the lower region section wₘ, and the facial action coordinates x′ are inputted into the rendering NeRF, to obtain a facial color c and a facial density σ. During generation of the facial color c, since the color is affected by a view direction, ambient lighting, or the like, the view direction and an appearance code d (θ, Φ, ψ) need to be inputted into the rendering NeRF, to complete the 3D facial reconstruction.

In this embodiment, the decoupling loss is determined by controlling a variable through a combination of the latent codes at different moments, so that the decoupling NeRF is trained through the decoupling loss, which may improve decoupling accuracy, thereby helping to improve accuracy of decoupling control.

In the foregoing embodiments, the facial modeling model may be trained. The trained facial modeling model may be used in a process of driving a face by text, which is to be described below by using an exemplary embodiment.

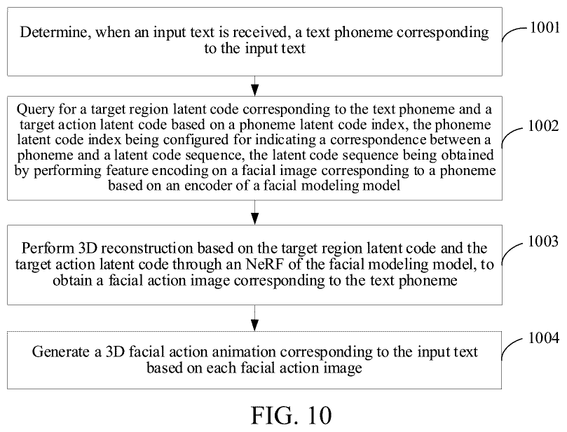

FIG. 10 is a flowchart showing a 3D facial modeling method according to an exemplary embodiment of this application. This embodiment is described by using an example in which the method is applied to an electronic device. The method includes the following operations.

Operation 1001: Determine, when an input text is received, a text phoneme corresponding to the input text.

In a possible implementation, an electronic device has a program of driving a face by text run therein. When receiving the input text, the electronic device may determine a text phoneme corresponding to the input text, to obtain a text phoneme sequence corresponding to the input text.

Operation 1002: Query for a target region latent code corresponding to the text phoneme and a target action latent code based on a phoneme latent code index, the phoneme latent code index being configured for indicating a correspondence between a phoneme and a latent code sequence, the latent code sequence being obtained by performing feature encoding on a facial image corresponding to a phoneme based on an encoder of a facial modeling model.

After the facial modeling model is obtained through the foregoing training, the encoder in the model may encode the facial image to obtain different latent codes. In a possible implementation, the electronic device may encode the facial images corresponding to different phonemes by using the encoder, to obtain a latent code sequence corresponding to different phonemes. The latent code sequence corresponding to each phoneme includes a facial region latent code and a facial action latent code. A phoneme latent code index may be established based on a result of encoding the facial image by the encoder, which is configured for indicating a correspondence between the phoneme and the latent code sequence.

In a possible implementation, the electronic device may query for the latent code sequence corresponding to each phoneme, to obtain a target region latent code and a target action latent code corresponding to each phoneme. Exemplarily, when a text includes a Chinese character “ [symbol] ”, which indicates that phonemes “p” and “u” are included, queries are respectively performed to obtain a facial region latent code and a facial action latent code corresponding to “p” and a facial region latent code and a facial action latent code corresponding to “u.”

Alternatively, in another possible implementation, a phoneme sequence may be determined first, and queries are performed based on the phoneme sequence to obtain a corresponding latent code sequence. To be specific, queries are performed to obtain a latent code sequence corresponding to “pu.” In some embodiments, a longest common subsequence search manner may be adopted to search for the latent code corresponding to the phoneme.

The facial image corresponding to the phoneme may be an image acquired in advance. For different pronunciations of the phoneme, facial images corresponding to the pronunciations may be respectively acquired. Exemplarily, for a phoneme of the same text, a facial image corresponding to a Mandarin pronunciation, a facial image corresponding to a dialect pronunciation, a facial image corresponding to a singing pronunciation, and the like may be respectively acquired. Therefore, a latent code sequence (i.e., a phoneme latent code index corresponding to Mandarin is established) corresponding to phonemes in a Mandarin pronunciation, a latent code sequence (a phoneme latent code index corresponding to dialects) corresponding to phonemes in a dialect pronunciation, and a latent code sequence (a phoneme latent code index corresponding to singing) corresponding to phonemes in singing may be encoded, thereby providing users with different facial driving manners.

During searching for a latent code sequence corresponding to phonemes based on a phoneme latent code index, a corresponding phoneme latent code index may be determined based on a pronunciation selected by a user, thereby finding a corresponding latent code sequence.

Operation 1003: Perform 3D reconstruction based on the target region latent code and the target action latent code through an NeRF of the facial modeling model, to obtain a facial action image corresponding to the text phoneme.

During actual implementation, the 3D reconstruction is performed based on the target region latent code and the target action latent code through the NeRF of the facial modeling model, to obtain a process of the facial action image corresponding to the text phoneme. In other words, the target region latent code and the target action latent code are inputted into the NeRF of the facial modeling model to perform the 3D reconstruction, to obtain the facial action image corresponding to the text phoneme.

During determining of the latent code sequence corresponding to the text phoneme, the latent code sequence may be inputted into the NeRF to perform the 3D reconstruction. In a possible implementation, the target action latent code may be inputted into the action NeRF, to obtain an action transformation matrix, 3D facial coordinates set in advance are transformed through the action transformation matrix, to obtain facial action coordinates after the action transformation. Then the facial action coordinates and an upper region latent code are inputted into an upper NeRF to obtain an upper region section, and then the facial action coordinates and a lower region latent code are inputted into a lower NeRF to obtain a lower region section. Finally, the upper region section, the lower region section, and the facial action coordinates are inputted into a rendering NeRF, and the facial action image corresponding to the text phoneme is rendered.

The text phoneme corresponding to the input text includes a plurality of phonemes. In a possible implementation, the latent code sequence corresponding to each text phoneme is inputted into the NeRF, to obtain a reading facial image corresponding to each text phoneme. During a query for the latent code sequence corresponding to the text phoneme, some of latent codes corresponding to adjacent phonemes may be the same. For example, two adjacent phonemes correspond to the same upper region latent code. In this case, during reconstruction of a facial action image corresponding to a second phoneme, only changed latent codes (such as the lower region latent code and the facial action latent code) need to be inputted into the NeRF to perform the 3D reconstruction, thereby implementing long-sequence 3D facial modeling.

Operation 1004: Generate a 3D facial action animation corresponding to the input text based on each facial action image.

After a plurality of facial action images are generated, the electronic device combines the plurality of facial action images to obtain a 3D facial action animation corresponding to the input text, providing authenticity of q 3D facial simulation pronunciation. To be specific, in a case that the electronic device receives the input text, a 3D facial reading animation corresponding to the input text may be generated. In a case that the text changes, the animation changes accordingly, thereby implementing a manner of driving a 3D face by text, and improving authenticity of simulation.

In this embodiment, feature encoding is performed on the facial images corresponding to different phonemes through the encoder, to obtain a correspondence between different phonemes and the latent code sequence, and the phoneme latent code index is stored. When the electronic device receives the text inputted by the user, queries may be performed based on the phoneme latent code index to obtain the corresponding latent code sequence, and then the latent code sequence is inputted into the NeRF, to obtain the 3D facial action animation corresponding to the input text, and drive the 3D face by text. The user may change the 3D facial animation by changing the input text, thereby improving applicability of facial driving. In addition, since the NeRF may perform decoupling control on a face, part of the latent code can be adjusted when only a partial region needs to be changed, which facilitates the long-sequence 3D facial modeling.

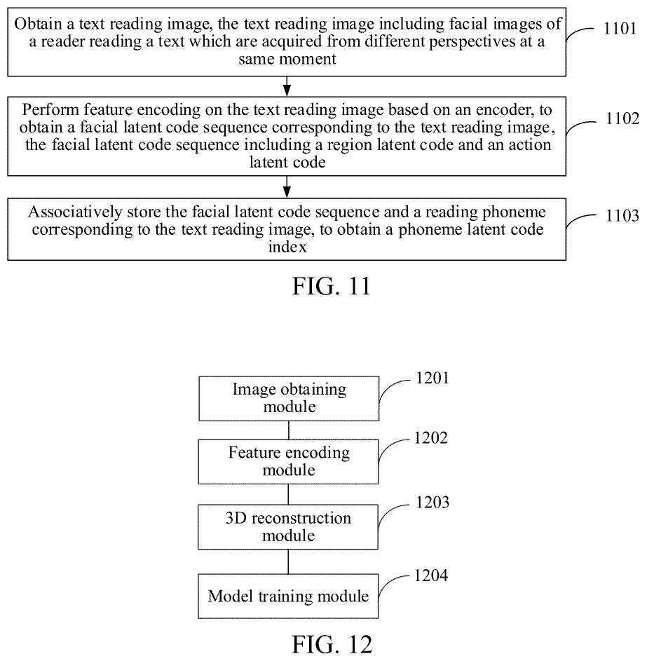

The phoneme latent code index is determined based on results of encoding different facial images by the encoder in the facial modeling model. Different phoneme latent code indexes may be established for different pronunciations. facial actions corresponding to different pronunciation manners may be simulated through different phoneme latent code indexes, to generate the corresponding 3D facial action animation. For example, a 3D facial action animation corresponding to simulation of Mandarin, dialects, or singing may be obtained, which enriches diversity of driving a face by text. A description is provided by using an example in which a process of establishing a phoneme latent code index in a manner of reading a text is used. FIG. 11 is a flowchart showing generation of a phoneme latent code index according to an exemplary embodiment of this application. The process includes the following operations.

Operation 1101: Obtain a text reading image, the text reading image including facial images of a reader reading a text which are acquired from different perspectives at a same moment.

In a possible implementation, facial images of a reader reading different texts may be acquired through a multi-perspective camera acquisition system. In this process, audio and video recording may be simultaneously performed to obtain a reading video and a reading audio. The reading video includes the facial image of the reader.

The reading audio is aligned with the reading text to determine a timeline corresponding to each phoneme. The text reading image corresponding to each phoneme may be determined based on the timeline corresponding to each phoneme. The text reading image corresponding to each phoneme includes facial images acquired from different perspectives.

Operation 1102: Perform feature encoding on the text reading image based on an encoder, to obtain a facial latent code sequence corresponding to the text reading image, the facial latent code sequence including a region latent code and an action latent code.

During actual implementation, feature encoding is performed on the text reading image based on the encoder, to obtain the facial latent code sequence corresponding to the text reading image. The facial latent code sequence includes the region latent code and the action latent code. In other words, the text reading image is inputted into the encoder to perform feature encoding, to obtain the facial latent code sequence corresponding to the text reading image.

The electronic device may perform feature encoding on the text reading image corresponding to each phoneme by using the encoder. In this process, a facial state latent code for characterizing an overall state is first encoded by the encoding network, and then the facial region latent code and the facial action latent code are decoupled by the decoupling NeRF, to obtain the latent code sequence corresponding to each phoneme.

Operation 1103: Associatively store the facial latent code sequence and a reading phoneme corresponding to the text reading image, to obtain the phoneme latent code index.

The electronic device may associatively store the facial latent code sequence and the corresponding reading phoneme, which are subsequently used in a process of driving the face based on the text.

FIG. 12 is a structural block diagram showing a training apparatus for a facial modeling model according to an exemplary embodiment of this application. The apparatus includes:
an image obtaining module 1201, configured to obtain a sample facial image, the sample facial image including facial images of a same object from different perspectives at a same moment;
a feature encoding module 1202, configured to perform feature encoding on the sample facial image through an encoder of the facial modeling model, to obtain a facial region latent code corresponding to a different facial region and a facial action latent code corresponding to a facial action;
a 3D reconstruction module 1203, configured to perform 3D facial reconstruction on the object based on the facial region latent code and the facial action latent code through an NeRF of the facial modeling 1203 model, to obtain a 3D facial image of the object; and
a model training module 1204, configured to obtain a 3D reconstruction loss between the 3D facial image and the sample facial image 1204, and train the facial modeling model based on the 3D reconstruction loss.

In some embodiments, the NeRF includes a region NeRF, an action NeRF, and a rendering NeRF.

The 3D reconstruction module 1203 is further configured to:
input the facial action latent code into the action NeRF, to obtain an action transformation matrix;
obtain 3D facial coordinates of the object based on the sample facial image, and perform action transformation on the 3D facial coordinates based on the action transformation matrix, to obtain facial action coordinates;
input the facial action coordinates and the facial region latent code into the region NeRF, to obtain a facial region section, a feature dimension of the facial region section being greater than a feature dimension of the facial region latent code;
input the facial action coordinates and the facial region section into the rendering NeRF, to obtain a facial color and a facial density; and
generate the 3D facial image based on the facial color and the facial density.

The feature encoding module 1202 is further configured to: perform feature encoding on the sample facial image through the encoder of the facial modeling model, to obtain an upper region latent code, a lower region latent code, and the facial action latent code, the upper region latent code being configured for characterizing a facial feature of an upper half face, and the lower region latent code being configured for characterizing a facial feature of a lower half face; and
The 3D reconstruction module 1203 is further configured to:
input the facial action coordinates and the upper region latent code into an upper NeRF, to obtain an upper region section;
input the facial action coordinates and the lower region latent code into a lower NeRF, to obtain a lower region section; and
obtain the facial region section based on the upper region section and the lower region section.

The model training module 1204 is further configured to:
determine a pixel error loss based on a pixel difference between the 3D facial image and the sample facial image;
determine a mask error loss based on a mask difference between the 3D facial image and the sample facial image; and
determine the 3D reconstruction loss based on the pixel error loss and the mask error loss.

In some embodiments, the encoder includes an encoding network and a decoupling NeRF.

The feature encoding module 1202 is further configured to:
perform feature encoding on the sample facial image through the encoding network, to obtain a facial state latent code, the facial state latent code being configured for characterizing an overall facial state of the object corresponding to the sample facial image when reading a text; and
decouple the facial state latent code through the decoupling NeRF, to obtain an upper region latent code, a lower region latent code, and the facial action latent code, and determine the facial region latent code based on the upper region latent code and the lower region latent code,
the upper region latent code being configured for characterizing the facial feature of the upper half face, and the lower region latent code being configured for characterizing the facial feature of the lower half face.

In some embodiments, the apparatus further includes:
a loss determination module, configured to determine a decoupling loss based on the upper region latent codes, the lower region latent codes, and the facial action latent codes at different moments, the decoupling loss being configured for characterizing a difference in facial decoupling at different moments and training the decoupling NeRF.

The model training module 1204 is further configured to train the facial modeling model based on the decoupling loss and the 3D reconstruction loss.

In some embodiments, the loss determination module is further configured to:
obtain a first upper region latent code, a first lower region latent code, and a first facial action latent code corresponding to the sample facial image at a first moment, and obtain a second upper region latent code, a second lower region latent code, and a second facial action latent code corresponding to the sample facial image at a second moment;
determine an upper decoupling loss based on the first upper region latent code, the first facial action latent code, and the second lower region latent code;
determine a lower decoupling loss based on the first lower region latent code, the first facial action latent code, and the second upper region latent code;
determine an action decoupling loss based on the second facial action latent code, the first upper region latent code, and the first lower region latent code; and
determine the decoupling loss based on the upper decoupling loss, the lower decoupling loss, and the action decoupling loss.

In some embodiments, the loss determination module is further configured to:
input the first upper region latent code, the first facial action latent code, and the second lower region latent code into the NeRF, to obtain a first facial image; and
determine the upper decoupling loss based on a difference between an upper half face in the first facial image and an upper half face in the sample facial image at the first moment.

In some embodiments, the loss determination module is further configured to:
input the first lower region latent code, the first facial action latent code, and the second upper region latent code into the NeRF, to obtain a second facial image; and
determine the lower decoupling loss based on a difference between a lower half face in the second facial image and a lower half face in the sample facial image at the first moment.

In some embodiments, the loss determination module is further configured to:
input the second facial action latent code, the first upper region latent code, and the first lower region latent code into the NeRF, to obtain a third facial image; and
determine the action decoupling loss based on a difference between a mask of the third facial image and a mask of the sample facial image at the first moment.

In the embodiments of this application, feature encoding is performed on the sample facial images from a plurality of perspectives, to obtain the facial region latent code and the facial action latent code corresponding to the sample facial image, which are configured for characterizing region features of different facial regions and action features of a face. Then 3D reconstruction is performed through the facial region latent code and the facial action latent code, to obtain the 3D facial image. Therefore, a facial modeling model that may perform decoupling control on the face is trained based on the difference between the 3D facial image and the sample facial image. When a model is configured for 3D facial modeling, decoupling control may be performed on different facial regions and facial actions, so that a facial image with different facial regions and different facial action combinations may be generated. During the 3D facial modeling, only part of the latent code that needs to be changed needs to be adjusted, so that the long-sequence 3D facial modeling may be implemented.

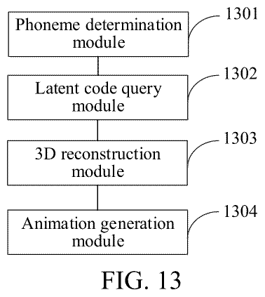

FIG. 13 is a structural block diagram showing a 3D facial modeling apparatus according to an exemplary embodiment of this application. The apparatus includes:
a phoneme determination module 1301, configured to determine, when an input text is received, a text phoneme corresponding to the input text;
a latent code query module 1302, configured to query for a target region latent code corresponding to the text phoneme and a target action latent code based on a phoneme latent code index, the phoneme latent code index being configured for indicating a correspondence between a phoneme and a latent code sequence, the latent code sequence being obtained by performing feature encoding on a facial image corresponding to a phoneme based on an encoder of a facial modeling model;
a 3D reconstruction module 1303, configured to perform 3D reconstruction based on the target region latent code and the target action latent code through an NeRF of the facial modeling model, to obtain a facial action image corresponding to the text phoneme; and
an animation generation module 1304, configured to generate a 3D facial action animation corresponding to the input text based on each facial action image.

In some embodiments, the apparatus further includes:
an image obtaining module, configured to obtain a text reading image, the text reading image including facial images of a reader reading a text which are acquired from different perspectives at a same moment;
a feature encoding module, configured to perform feature encoding on the text reading image based on the encoder, to obtain a facial latent code sequence corresponding to the text reading image, the facial latent code sequence including a region latent code and an action latent code; and
a storage module, configured to associatively store the facial latent code sequence and a reading phoneme corresponding to the text reading image, to obtain the phoneme latent code index.

In this embodiment, feature encoding is performed on the facial images corresponding to different phonemes through the encoder, to obtain a correspondence between different phonemes and the latent code sequence, and the phoneme latent code index is stored. When the electronic device receives the text inputted by the user, queries may be performed based on the phoneme latent code index to obtain the corresponding latent code sequence, and then the latent code sequence is inputted into the NeRF, to obtain the 3D facial action animation corresponding to the input text, and drive the 3D face by text. The user may change the 3D facial animation by changing the input text, thereby improving applicability of facial driving. In addition, since the NeRF may perform decoupling control on a face, part of the latent code can be adjusted when only a partial region needs to be changed, which facilitates the long-sequence 3D facial modeling.

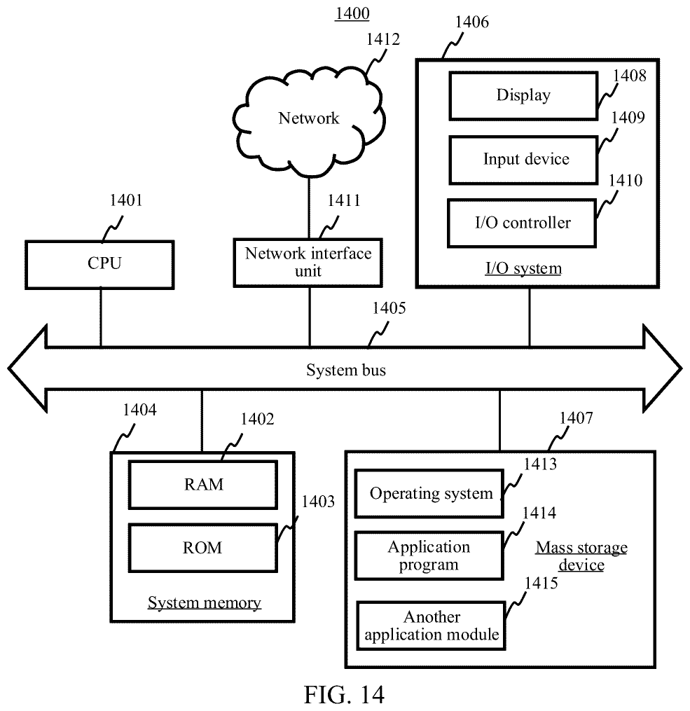

FIG. 14 is a schematic structural diagram showing an electronic device according to an exemplary embodiment of this application. The electronic device may be implemented as the terminal or the server in the foregoing embodiment. The electronic device 1400 includes a central processing unit (CPU) 1401, a system memory 1404 including a random access memory (RAM) 1402 and a read-only memory (ROM) 1403, and a system bus 1405 connected to the system memory 1404 to the CPU 1401. The electronic device 1400 further includes a basic input/output (I/O) system 1406 for facilitating information transmission between devices in a computer, and a mass storage device 1407 configured to store an operating system 1413, an application program 1414, and another program module 1415.

In some embodiments, the basic I/O system 1406 includes a display 1408 configured to display information and an input device 1409 such as a mouse and a keyboard for a user to input information. The display 1408 and the input device 1409 are both connected to the CPU 1401 through an I/O controller 1410 connected to the system bus 1405. The basic I/O system 1406 may further include the I/O controller 1410 to be configured to receive and process inputs from a plurality of other devices such as a keyboard, a mouse, and an electronic stylus. Similarly, the I/O controller 1410 further provides an output to a display screen, a printer, or another type of output device.

The mass storage device 1407 is connected to the CPU 1401 by using a mass storage controller (not shown) connected to the system bus 1405. The mass storage device 1407 and a computer-readable medium associated with the mass storage device provide non-volatile storage for the electronic device 1400. In other words, the mass storage device 1407 may include a computer-readable medium (not shown) such as a hard disk or a drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes the RAM, the ROM, a flash memory or another solid-state memory, a compact disc read-only memory (CD-ROM), a digital versatile disc (DVD) or another optical memory, a magnetic cassette, a magnetic tape, a disk memory, or another magnetic storage device. Certainly, a person skilled in the art may learn that the computer storage medium is not limited to the foregoing several types. The foregoing system memory 1404 and the mass storage device 1407 may be collectively referred to as a memory.

The memory has one or more programs stored therein, the one or more programs being configured to be executed by one or more CPUs 1401, and the one or more programs including instructions for implementing the foregoing method. The CPU 1401 executes the one or more programs to implement the method provided in the foregoing method embodiments.

According to the embodiments of this application, the electronic device 1400 may be further connected to a remote computer on a network for running through a network such as the Internet. In other words, the electronic device 1400 may be connected to a network 1412 through a network interface unit 1411 connected to the system bus 1405, or may be connected to another type of network or a remote computer system (not shown) by using the network interface unit 1411.

The memory further includes one or more programs, the one or more programs being stored in the memory and including operations to be performed by the electronic device for performing the method provided in the embodiments of this application.

An embodiment of this application further provides a computer-readable storage medium, the computer-readable storage medium having at least one instruction, at least one program, a code set, or an instruction set stored therein, the at least one instruction, the at least one program, the code set, or the instruction set being loaded and executed by a processor to implement the training method for a facial modeling model according to any one of the foregoing embodiments, or to implement the 3D facial modeling method according to any one of the foregoing embodiments.

An embodiment of this application provides a computer program product or a computer program, the computer program product or the computer program including a computer instruction, the computer instruction being stored in a computer-readable storage medium. A processor of an electronic device reads the computer instruction from the computer-readable storage medium, the processor executing the computer instruction, to cause the electronic device to perform the training method for a facial modeling model provided in the foregoing aspect, or to implement the 3D facial modeling method according to any one of the foregoing embodiments.

A person of ordinary skill in the art may understand that all or some of the operations of the methods in the embodiments may be implemented by a program instructing relevant hardware. The program may be stored in a computer-readable storage medium. The computer-readable storage medium may be the computer-readable storage medium included in the memory in the foregoing embodiment, or may be a computer-readable storage medium that exists alone and is not assembled into a terminal. The computer-readable storage medium has at least one instruction, at least one program, a code set, or an instruction set stored therein, the at least one instruction, the at least one program, the code set, or the instruction set being loaded and executed by a processor to implement the training method for a facial modeling model according to any one of the foregoing method embodiments, or to implement the 3D facial modeling method according to any one of the foregoing embodiments.

In some embodiments, the computer-readable storage medium may include a ROM, a RAM, a solid state drive (SSD), an optical disc, or the like. The RAM may include a resistance RAM (ReRAM) and a dynamic RAM (DRAM). The sequence numbers of the foregoing embodiments of this application are merely for description, and do not represent the preference of the embodiments.

A person of ordinary skill in the art may understand that all or part of the operations of implementing the foregoing embodiments may be implemented by hardware, or may be implemented by a program instructing related hardware. The program may be stored in a computer-readable storage medium. The storage medium mentioned above may be a ROM, a magnetic disk, an optical disc, or the like.

“A plurality of” mentioned herein means two or more. The term “and/or” is an association relationship for describing associated objects and represents that three relationships may exist. For example, A and/or B may represent the following three cases: only A exists, both A and B exist, and only B exists. The character “/” generally indicates an “or” relationship between a preceding associated object and a latter associated object. Terms “first,” “second,” and the like mentioned herein are configured for distinguishing between similar objects, and are not intended to limit a specific order or sequence. In addition, the operation numbers described in this specification merely exemplarily show a possible execution sequence of the operations. In some other embodiments, the foregoing operations may not be performed based on the number sequence. For example, two operations with different numbers may be performed simultaneously, or two operations with different numbers may be performed based on a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application falls within the protection scope of this application.

What is claimed is:

1. A training method, performed by an electronic device, comprising:
obtaining a sample facial image including facial images of a same object from different perspectives at a same moment;
performing feature encoding on the sample facial image through an encoder of a facial modeling model, to obtain a facial action latent code corresponding to a facial action and one or more facial region latent codes each corresponding to one of one or more facial regions;
performing, through a neural radiance field (NeRF) of the facial modeling model, three-dimensional (3D) facial reconstruction on the object based on the one or more facial region latent codes and the facial action latent code, to obtain a 3D facial image of the object;
obtaining a 3D reconstruction loss between the 3D facial image and the sample facial image; and
training the facial modeling model based on the 3D reconstruction loss.

2. The method according to claim 1, wherein:
the NeRF includes a region NeRF, an action NeRF, and a rendering NeRF; and
performing 3D facial reconstruction on the object includes:
inputting the facial action latent code into the action NeRF, to obtain an action transformation matrix;
obtaining 3D facial coordinates of the object based on the sample facial image, and performing action transformation on the 3D facial coordinates based on the action transformation matrix, to obtain facial action coordinates;
inputting the facial action coordinates and the one or more facial region latent codes into the region NeRF, to obtain one or more facial region sections each corresponding to one of the one or more facial region latent codes, a feature dimension of each of the one or more facial region sections being greater than a feature dimension of a corresponding one of the one or more facial region latent codes;
inputting the facial action coordinates and the one or more facial region sections into the rendering NeRF, to obtain a facial color and a facial density; and
generating the 3D facial image based on the facial color and the facial density.

3. The method according to claim 2, wherein:
performing feature encoding on the sample facial image includes:
performing feature encoding on the sample facial image through the encoder of the facial modeling model, to obtain an upper region latent code characterizing a facial feature of an upper half face, a lower region latent code characterizing a facial feature of a lower half face, and the facial action latent code; and
inputting the facial action coordinates and the one or more facial region latent codes into the region NeRF, to obtain the one or more facial region sections includes:
inputting the facial action coordinates and the upper region latent code into an upper NeRF, to obtain an upper region section; and
inputting the facial action coordinates and the lower region latent code into a lower NeRF, to obtain a lower region section.

4. The method according to claim 1, wherein obtaining the 3D reconstruction loss includes:
determining a pixel error loss based on a pixel difference between the 3D facial image and the sample facial image;
determining a mask error loss based on a mask difference between the 3D facial image and the sample facial image; and
determining the 3D reconstruction loss based on the pixel error loss and the mask error loss.

5. The method according to claim 1, wherein:
the encoder includes an encoding network and a decoupling NeRF; and
performing feature encoding on the sample facial image includes:
performing feature encoding on the sample facial image through the encoding network, to obtain a facial state latent code characterizing an overall facial state of the object when reading a text; and
decoupling the facial state latent code through the decoupling NeRF, to obtain an upper region latent code characterizing a facial feature of an upper half face, a lower region latent code characterizing a facial feature of a lower half face, and the facial action latent code.

6. The method according to claim 5, further comprising:
determining a decoupling loss based on the upper region latent code, the lower region latent code, and the facial action latent code at different moments, the decoupling loss characterizing a difference in facial decoupling at different moments and being configured for training the decoupling NeRF; and
training the facial modeling model includes training the facial modeling model based on the decoupling loss and the 3D reconstruction loss.

7. The method according to claim 6, wherein determining the decoupling loss includes:
obtaining a first upper region latent code, a first lower region latent code, and a first facial action latent code corresponding to the sample facial image at a first moment;
obtaining a second upper region latent code, a second lower region latent code, and a second facial action latent code corresponding to the sample facial image at a second moment;
determining an upper decoupling loss based on the first upper region latent code, the first facial action latent code, and the second lower region latent code;
determining a lower decoupling loss based on the first lower region latent code, the first facial action latent code, and the second upper region latent code;
determining an action decoupling loss based on the second facial action latent code, the first upper region latent code, and the first lower region latent code; and
determining the decoupling loss based on the upper decoupling loss, the lower decoupling loss, and the action decoupling loss.

8. The method according to claim 7, wherein:
determining the upper decoupling loss includes:
inputting the first upper region latent code, the first facial action latent code, and the second lower region latent code into the NeRF, to obtain a first facial image; and
determining the upper decoupling loss based on a difference between an upper half face in the first facial image and an upper half face in the sample facial image at the first moment; and
determining the lower decoupling loss includes:
inputting the first lower region latent code, the first facial action latent code, and the second upper region latent code into the NeRF, to obtain a second facial image; and
determining the lower decoupling loss based on a difference between a lower half face in the second facial image and a lower half face in the sample facial image at the first moment.

9. The method according to claim 7, wherein determining the action decoupling loss includes:
inputting the second facial action latent code, the first upper region latent code, and the first lower region latent code into the NeRF, to obtain a third facial image; and
determining the action decoupling loss based on a difference between a mask of the third facial image and a mask of the sample facial image at the first moment.

10. A non-transitory computer-readable storage medium storing one or more computer-executable instructions that, when executed by a processor, cause the processor to perform the training method according to claim 1.

11. A three-dimensional (3D) facial modeling method, performed by an electronic device, comprising:
determining, in response to receiving an input text, a text phoneme corresponding to the input text;
querying for a target region latent code corresponding to the text phoneme and a target action latent code based on a phoneme latent code index, the phoneme latent code index indicating a correspondence between a phoneme and a latent code sequence, and the latent code sequence being obtained by performing feature encoding on a facial image corresponding to a phoneme based on an encoder of a facial modeling model;
performing, through a neural radiance field (NeRF) of the facial modeling model, 3D reconstruction based on the target region latent code and the target action latent code, to obtain one or more facial action images corresponding to the text phoneme; and
generating a 3D facial action animation corresponding to the input text based on the one or more facial action images.

12. The method according to claim 11, further comprising:
obtaining a text reading image including facial images of a reader reading a text which are acquired from different perspectives at a same moment;
performing feature encoding on the text reading image based on the encoder, to obtain a facial latent code sequence corresponding to the text reading image, the facial latent code sequence including one or more region latent codes and an action latent code; and
associatively storing the facial latent code sequence and a reading phoneme corresponding to the text reading image, to obtain the phoneme latent code index.

13. An electronic device comprising:
a memory storing one or more computer-executable instructions; and
a processor configured to execute the one or more computer-executable instructions to implement the 3D facial modeling method according to claim 11.

14. A non-transitory computer-readable storage medium storing one or more computer-executable instructions that, when executed by a processor, cause the processor to perform the training method according to claim 11.

15. An electronic device comprising:
a memory storing one or more computer-executable instructions; and
a processor configured to execute the one or more computer-executable instructions to:
obtain a sample facial image including facial images of a same object from different perspectives at a same moment;
perform feature encoding on the sample facial image through an encoder of a facial modeling model, to obtain a facial action latent code corresponding to a facial action and one or more facial region latent codes each corresponding to one of one or more facial regions;
perform, through a neural radiance field (NeRF) of the facial modeling model, three-dimensional (3D) facial reconstruction on the object based on the one or more facial region latent codes and the facial action latent code, to obtain a 3D facial image of the object;
obtain a 3D reconstruction loss between the 3D facial image and the sample facial image; and
train the facial modeling model based on the 3D reconstruction loss.

16. The electronic device according to claim 15, wherein:
the NeRF includes a region NeRF, an action NeRF, and a rendering NeRF; and
the processor is further configured to execute the one or more computer-executable instructions to, when performing 3D facial reconstruction on the object:
input the facial action latent code into the action NeRF, to obtain an action transformation matrix;
obtain 3D facial coordinates of the object based on the sample facial image, and performing action transformation on the 3D facial coordinates based on the action transformation matrix, to obtain facial action coordinates;
input the facial action coordinates and the one or more facial region latent codes into the region NeRF, to obtain one or more facial region sections each corresponding to one of the one or more facial region latent codes, a feature dimension of each of the one or more facial region sections being greater than a feature dimension of a corresponding one of the one or more facial region latent codes;
input the facial action coordinates and the one or more facial region sections into the rendering NeRF, to obtain a facial color and a facial density; and
generate the 3D facial image based on the facial color and the facial density.

17. The electronic device according to claim 16, wherein the processor is further configured to execute the one or more computer-executable instructions to:
when performing feature encoding on the sample facial image:
perform feature encoding on the sample facial image through the encoder of the facial modeling model, to obtain an upper region latent code characterizing a facial feature of an upper half face, a lower region latent code characterizing a facial feature of a lower half face, and the facial action latent code; and
when inputting the facial action coordinates and the one or more facial region latent codes into the region NeRF, to obtain the one or more facial region sections:
input the facial action coordinates and the upper region latent code into an upper NeRF, to obtain an upper region section; and
input the facial action coordinates and the lower region latent code into a lower NeRF, to obtain a lower region section.

18. The electronic device according to claim 15, wherein the processor is further configured to execute the one or more computer-executable instructions to, when obtaining the 3D reconstruction loss:
determine a pixel error loss based on a pixel difference between the 3D facial image and the sample facial image;
determine a mask error loss based on a mask difference between the 3D facial image and the sample facial image; and
determine the 3D reconstruction loss based on the pixel error loss and the mask error loss.

19. The electronic device according to claim 15, wherein:
the encoder includes an encoding network and a decoupling NeRF; and
the processor is further configured to execute the one or more computer-executable instructions to, when performing feature encoding on the sample facial image:
perform feature encoding on the sample facial image through the encoding network, to obtain a facial state latent code characterizing an overall facial state of the object when reading a text; and
decouple the facial state latent code through the decoupling NeRF, to obtain an upper region latent code characterizing a facial feature of an upper half face, a lower region latent code characterizing a facial feature of a lower half face, and the facial action latent code.

20. The electronic device according to claim 5, wherein the processor is further configured to execute the one or more computer-executable instructions to:
determine a decoupling loss based on the upper region latent code, the lower region latent code, and the facial action latent code at different moments, the decoupling loss characterizing a difference in facial decoupling at different moments and being configured for training the decoupling NeRF; and
train the facial modeling model includes training the facial modeling model based on the decoupling loss and the 3D reconstruction loss.
